(19) United States
(12) Patent Application Publication
(10) Pub. No.: US 2013/0194272 A1
(43) Pub. Date: Aug. 1, 2013

(54) PLACING PIXELS ACCORDING TO ATTRIBUTE VALUES IN POSITIONS IN A GRAPHICAL VISUALIZATION THAT CORRESPOND TO GEOGRAPHIC LOCATIONS

(71) Applicants: MING C. HAO, Palo Alto, CA (US); Halldór Janetzko, Konstanz (DE); Daniel Keim, Steisslingen (DE); Umeshwar Dayal, Saratoga, CA (US); Lars-Erik Haug, Gilroy, CA (US); Meichun Hsu, Los Altos Hills, CA (US)

(72) Inventors: MING C. HAO, Palo Alto, CA (US); Halldór Janetzko, Konstanz (DE); Daniel Keim, Steisslingen (DE); Umeshwar Dayal, Saratoga, CA (US); Lars-Erik Haug, Gilroy, CA (US); Meichun Hsu, Los Altos Hills, CA (US)

(21) Appl. No.: 13/363,602

(22) Filed: Feb. 1, 2012

(51) Int. Cl. G06T 11/20

(52) U.S. Cl. 345/440

(57) ABSTRACT

Data records representing user feedback are received, where the data records are associated with geometric coordinates. Pixels representing the corresponding data records are placed in positions in a graphical visualization according to the geometric coordinates of the data records, where the positions correspond to geographic locations. A subset of the pixels sharing a particular set of geometric coordinates is placed in a subregion of nearby positions in the graphical representation, where the pixels in the subset are placed in an order in the subregion according to values of an attribute of the data records corresponding to the pixels in the subset.

### BACKGROUND

Customers can provide feedback, in the form of reviews, regarding offerings (products or services) of an enterprise. Reviews can be submitted online at third party sites (e.g. web survey sites or social networking sites such as Facebook and Twitter), or alternatively, reviews can be received directly by an enterprise. There can be potentially a very large number of received reviews, which can make meaningful analysis of such reviews difficult and time-consuming.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures:

FIGS. 1, 2 and 5 illustrate graphical visualizations for visualizing data records according to various implementations; and

FIG. 3 is a flow diagram of a geo-spatial visualization process according to some implementations;

FIG. 4 illustrates placement of pixels sharing geometric coordinates at corresponding pixel positions, in accordance with some implementations; and

FIG. 6 is a block diagram of an example system incorporating some implementations.

### DETAILED DESCRIPTION

An enterprise (e.g. a company, educational organization, government agency, etc.) may collect feedback from customers (or more generally “users”) to better understand user sentiment regarding an offering of the enterprise. An offering can include a product or a service provided by the enterprise. A “sentiment” refers to an attitude, opinion, or judgment of a human with respect to the offering.

If there are a relatively large number of users, then there can be relatively large amounts of user feedback. An enterprise can provide an online website to collect feedback from users. Alternatively or additionally, the enterprise can also collect feedback through telephone calls or on paper survey forms. Furthermore, feedback can be collected at third party sites, such as travel review websites, product review websites, social networking sites (such as Facebook and Twitter), web survey sites, and so forth. Some third party websites provide professional reviews of offerings from enterprises, as well as provide mechanisms for users to submit their individual reviews.

Traditionally, visualizations of sentiment feedback from users do not effectively express geo-spatial information, which is information indicating geographic locations associated with feedback data records provided by users. Without the geo-spatial information, analysis of sentiments expressed by users may not consider effects of geographic locations towards respective sentiments.

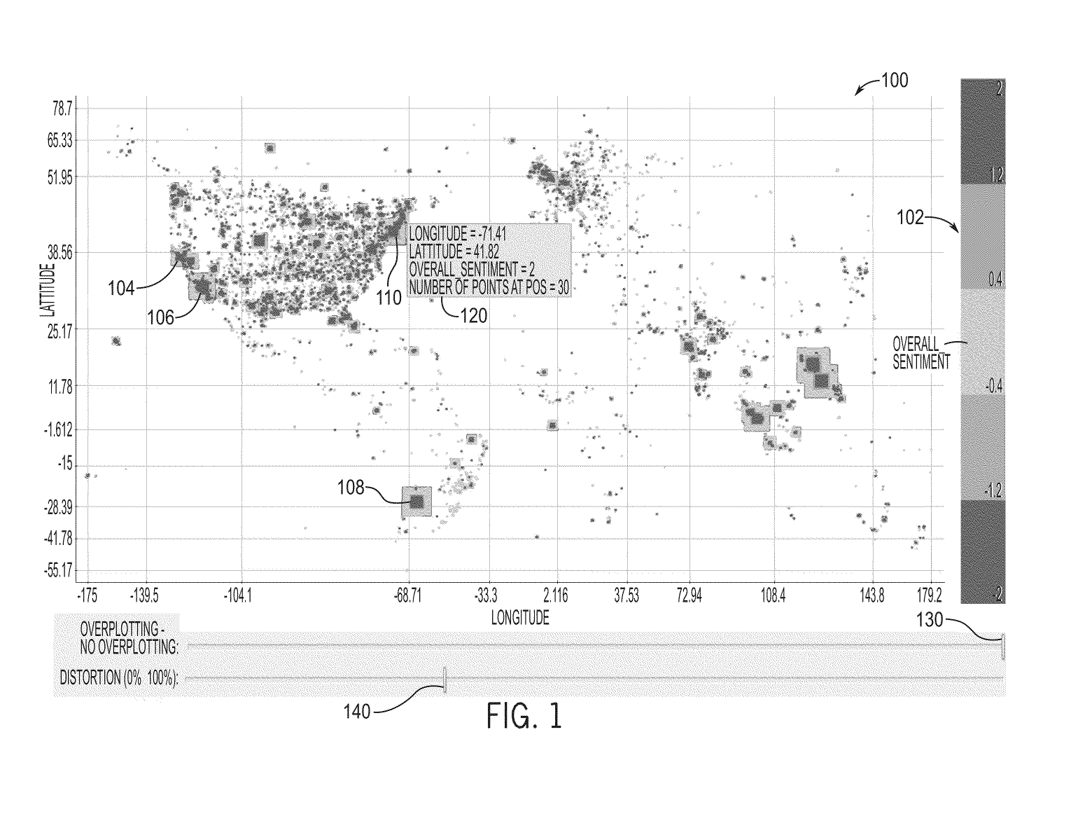

In accordance with some implementations, such as in examples according to FIG. 1, a graphical visualization 100 is provided that includes pixels representing sentiments in data records received in reviews submitted by users. In the graphical visualization 100, pixels are assigned various colors based on values of a sentiment attribute contained in the corresponding data records. The colors that can be assigned to the pixels in the graphical visualization 100 are represented in a color scale 102. In examples according to FIG. 1, the color scale 102 includes a dark green color, a light green color, a grey color, a light red color, and a dark red color. The green colors are used for indicating positive sentiment expressed by users, whereas the red colors are used to represent negative sentiments of users. The grey color is used to represent a neutral sentiment. The dark green color indicates a more positive sentiment than the light green color, while the dark red color indicates a more negative sentiment than the light red color.

Instead of using different colors to represent different sentiments, other types of visual indicators can be used instead, such as different fill patterns or different gray levels.

In some examples, the sentiment expressed in a particular data record can be based on scores assigned by a user (e.g. a score between 1 and 5, where 5 is positive while 1 is negative). In other examples, the sentiment expressed in a particular data record can be based on analysis of words in the data record—for example, the analysis can identify sentiment words associated with nouns representing targets of the sentiment words, and the sentiment words can be processed to determine the corresponding sentiment.

In the example of FIG. 1, the graphical visualization 100 has a vertical axis that represents a latitude, and a horizontal axis that represents a longitude. Thus, each pixel in the graphical visualization 100 corresponds to a particular combination of latitude and longitude (which define a unique geographic location). More generally, instead of expressing positions in the graphical visualization 100 as latitude and longitude, a position in the graphical visualization 100 can be expressed in terms of other geometric coordinates (e.g. x coordinate, y coordinate, etc.).

The data records representing corresponding user reviews contain location attributes, which can specify values for geometric coordinates (e.g. latitude and longitude) for each data record, where the specified values of the geometric coordinates represent the geographic location associated with the corresponding user review. Such geographic location can be the location of the user when the user submitted the review, the location of the entity that the review is about, and so forth.

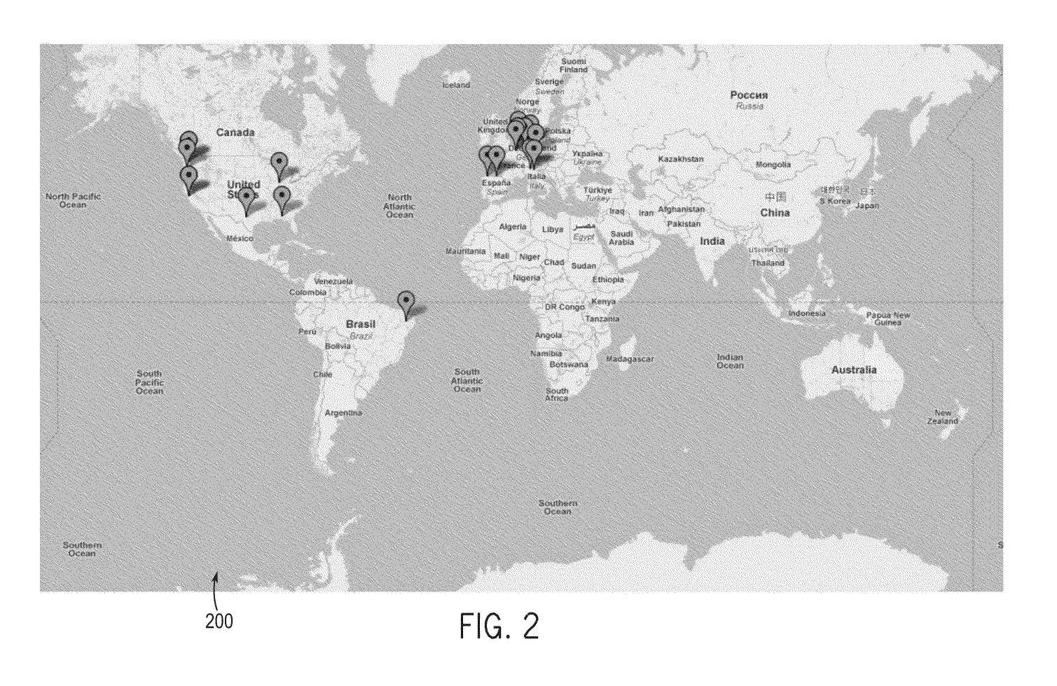

The positions of the various pixels in the graphical visualization 100 can correspond to positions on a geographic map, such as geographic map 200 shown in FIG. 2. In an example according to FIG. 1, most of the pixels are located at positions corresponding to North America. However, the graphical visualization 100 also includes pixels corresponding to other geographic regions.

By placing pixels representing user review data records in a graphical visualization according to positions that correspond to geographic locations, geo-spatial information can be provided to an analyst. As a result, the analyst can determine the correlation, if any, between geographic locations and corresponding sentiments (positive, negative, or neutral).

It is possible that there can be multiple data records that share the same values of geometric coordinates (e.g. same latitude and same longitude). This can occur when reviews are submitted by users in large cities, such as Los Angeles, San Francisco, New York City, and so forth. To avoid or reduce overlapping of pixels corresponding to data records that share the same geometric coordinates (which can result in occlusion of these pixels), techniques or mechanisms according to some implementations can place pixels representing data records that share the same geometric coordinates in nearby positions within a defined subregion. By placing pixels sharing the same geometric coordinates, clusters of such pixels are formed, to provide respective subregions (e.g. 104, 106, 108, or 110, among others in FIG. 1).

Each of subregions 104, 106, 108, and 110 contain pixels corresponding to data records that share a set of geometric coordinates (e.g. same latitude and longitude). For example, the subregion 104 can contain pixels corresponding to data records associated with San Francisco, the subregion 106 can contain pixels corresponding to data records associated with Los Angeles, the subregion 108 can contain pixels corresponding to data records associated with Buenos Aires, and the subregion 110 can contain pixels corresponding to data records associated with New York City.

If pixels corresponding to data records that share the same geometric coordinates were placed at the same position in the graphical visualization 100, then the graphical visualization 100 would indicate presence of just one data record at the position, even though potentially there can be hundreds or thousands of data records sharing the same geometric coordinates.

In some examples, each subregion of pixels that correspond to data records sharing the same geometric coordinates can have a generally rectangular shape (in some examples, a subregion can have a generally square shape). Placing pixels that share the same geometric coordinates in “nearby locations” can refer to pixels being placed in such close proximity that a user can detect the grouping of the visual indicator (e.g. colors) of the pixels, where the visual indicators indicate respective sentiment attribute values. Further details regarding a technique for avoiding or reducing overlay of pixels sharing common attribute values are provided in U.S. Ser. No. 12/381,716, “Constructing a Cell-Based Cluster of Data Records of a Scatterplot,” filed Mar. 16, 2009.

Using techniques or mechanisms according to some implementations, a relatively large quantity of data records can be visualized in a graphical visualization that provides geo-spatial information regarding the depicted data records. The ability to place pixels corresponding to data records that share geometric coordinates reduces or avoids occlusion of pixels corresponding to multiple data records. In addition to providing geo-spatial information of individual data records, density of data records at different geographic locations can also be depicted, such as by clustering pixels together in subregions for data records that share geometric coordinates. A region in the graphical visualization 100 having a relatively high density of pixels thus indicate reviews that are located in the same geographic location or are in a close neighborhood of geographic locations.

It is noted that in some examples, aggregation of pixels is not performed. Rather, the placement technique in which pixels representing data records that share the same geometric coordinates are placed in nearby positions is employed. Not aggregating pixels in the graphical visualization 100 allows for a user to move a cursor over individual pixels to obtain further information regarding the data records represented by the corresponding pixels.

Additional information regarding a data record represented by a particular pixel can be provided in a pop-up box 120. The pop-up box 120 can be displayed when a cursor is moved over the particular pixel in the graphical visualization 100.

FIG. 1 also shows user-adjustable control elements 130 and 140. In some examples, the user-adjustable control elements 130 and 140 can be slidable control elements that can be slid left or right. The control element 130 defines how much overlay (overplotting) is allowed for pixels in the graphical visualization 100. Moving the control element 130 to the right indicates that less overlay is to be allowed, while moving the control element 130 to the left indicates more overlay of pixels is allowed. Pixels representing data records that share the same geometric coordinates are placed in the graphical visualization 100 according to the degree of overlay allowed (based on input received by a system in response to a current position of the control element 130). Allowing more overlay means that some number of data records can share the same position on the graphical visualization 100. If no overlay is allowed, then just one pixel can be placed at a particular position of the graphical visualization 100; however, if some amount of overlay is allowed, then some predefined maximum number of pixels can be placed at a particular position in the graphical visualization 100.

The control element 140 is moveable left or right to control an amount of distortion of one of the axes in the graphical visualization. For example, the control element 140 can be moved to the right to apply greater distortion, where distortion of an axis, such as the horizontal axis, causes the axis to become non-linear in terms of scale.

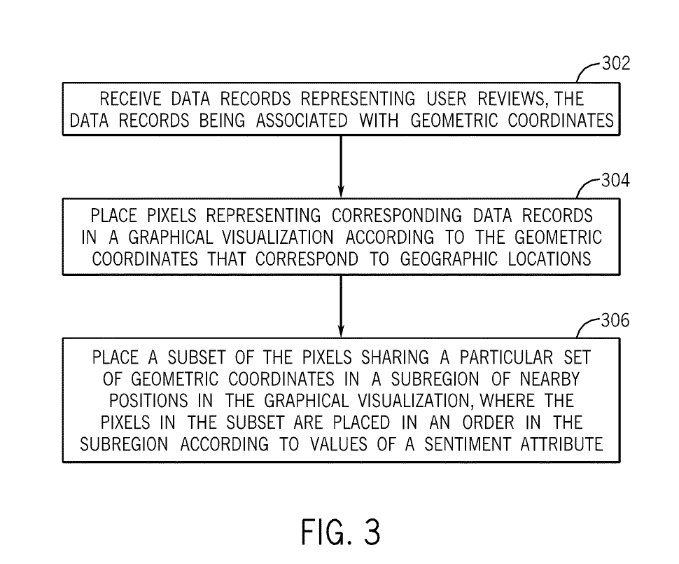

FIG. 3 is a flow diagram of a process according to some implementations. The process receives (at 302) data records representing user feedback (such as in the form of user reviews), where the data records are associated with geometric coordinates. The data records can be received in real-time; in other words, the data records are continually received as the reviews are received from various sources (e.g. website of an enterprise, websites of third parties, and so forth). In other examples, the received data records can be data records retrieved from a historical data set that contains data records previously acquired.

The process of FIG. 3 places (at 304) pixels representing the corresponding data records in positions in a graphical visualization (e.g. 100 in FIG. 1) according to the geometric coordinates of the data records, wherein the positions correspond to geographic locations. As noted above, the geometric coordinates can be contained in a location attribute associated with the data records.

The process then places (at 304) a subset of the pixels sharing a particular set of geometric coordinates (e.g. sharing the same latitude and longitude) in a subregion (e.g. one of the subregions 104, 106, 108, 110 in FIG. 1) of nearby positions in the graphical representation. The pixels in the subset are placed in an order in the subregion according to values of a sentiment attribute (or other attribute) of the data records corresponding to the pixels in the subset. In some examples, pixels that share the same sentiment attribute value (e.g. share a first sentiment attribute value) are placed adjacent each other in the subregion. Then, after the pixels that share the first sentiment attribute value are placed, pixels that have different sentiment attribute values are placed in order of similarity of the different sentiment attribute values to the first sentiment attribute value. In this way, within a subregion, subgroups of pixels having the same or similar colors can be visualized.

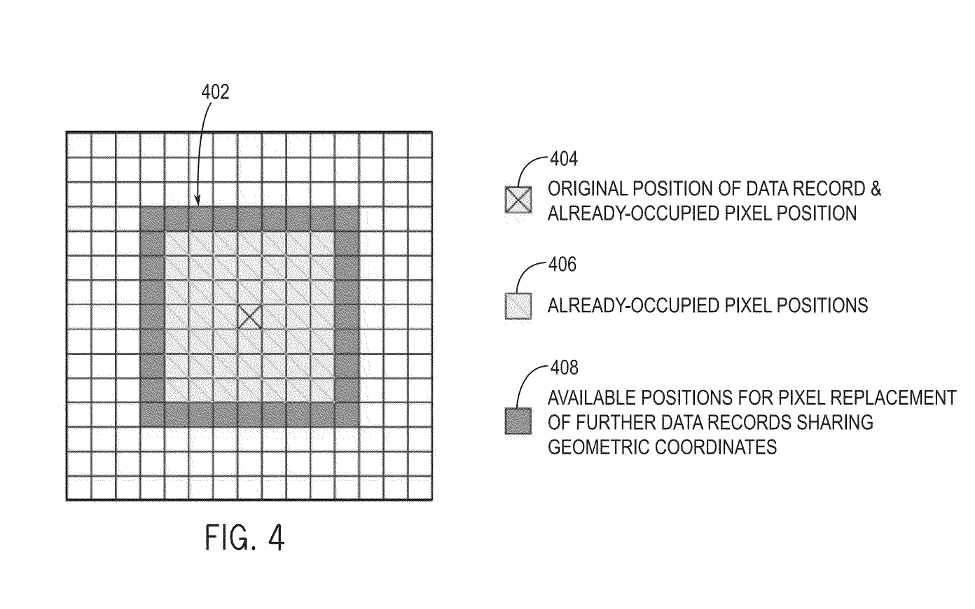

FIG. 4 illustrates an example of placement of pixels representing data records sharing geometric coordinates in a particular subregion 402. A position represented by pattern 404 represents the initial position that the pixel for a first data record having particular set of geometric coordinates is placed (e.g. the position represented by pattern 404 represents the initial position of latitude lat1 and longitude long1). Following receipt of this first data record, additional data records can be received that share the same particular geometric coordinates (e.g. lat1 and long1). The pixels for these additional data records are placed in positions represented by pattern 406, around the original position represented by pattern 404. The positions represented by pattern 406 are considered already-occupied pixel positions (positions occupied by respective pixels). As additional data records sharing the particular values of the geometric coordinates are received, such further data records can be placed in available positions surrounding the already-occupied positions represented by patterns 404 and 406. The available positions are represented by pattern 408.

In examples according to FIG. 4, the subregion 402 is a square. In other examples, other shapes can be employed, such as rectangles, circles, ellipses, and so forth.

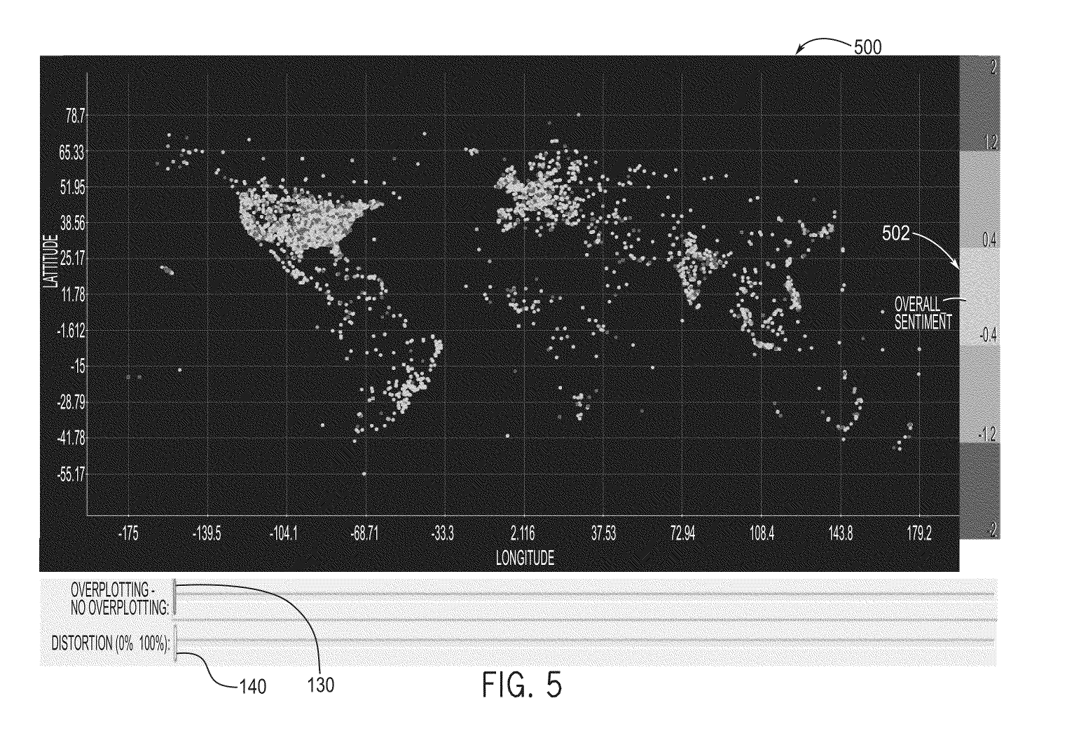

FIG. 5 shows another example graphical visualization 500, which includes various pixels assigned corresponding colors from color scale 502 (which is similar to color scale 102 in FIG. 1). The graphical visualization 500 also includes control elements 130 and 140. In the graphical visualization 500, the control element 130 (which controls the amount of overlay) has been moved all the way to the left, as compared to the control element 130 in FIG. 1, which was moved all the way to the right. Moving the control element 130 to the left allows for overlaying of pixels. Thus, as shown in FIG. 5, the clustering of pixels into subregions (as performed in FIG. 1) is not performed in FIG. 5. As a result, there can be overlaying of pixels representing data records that share the same geometric coordinates.

In either the graphical visualizations 100 or 500 shown in FIG. 1 or 5, respectively, a user can select a portion of the pixels depicted in the graphical visualization. Selection of such portion, such as by drawing a rectangular selection box around the portion, causes a zoomed-in view of this portion to be displayed.

The placement technique according to some examples is described in the pseudocode set forth below:

1 doPixelPlacement(OrderedList DataObjects)
2 int[ ][ ] overlapCount := new int[width][height];
3 for each o of DataObjects do
4 Point p := o.getPixelPos( );
5 if (overlapCount[p.x][p.y]<maxOverlap)
6 o.setPaintPos(p);
7 overlapCount[p.x][p.y]++;
8 else
9 rearrangeDataObject(o. p, overlapCount);
10 end for;

In the example above, the pseudocode represents a function doPixelPlacement( ), which is called to perform pixel placement according to some implementations. The input to the function doPixelPlacement( ) includes an ordered list of data records (OrderedList DataObjects), which can be ordered according to a predefined attribute of the data records in ascending or descending order.

At line 5 of the pseudocode above, a parameter overlapCount (for a particular set of coordinates represented by p.x and p.y) is compared to a predefined parameter maxOverlap (which indicates the number of pixels that can overlay each other at a particular position in a graphical visualization). The value of maxOverlap depends on the position of the control element 130 in FIG. 1 or 5. To avoid any overlap at a particular position in a graphical visualization, the value of maxOverlap is set to 1. On the other hand, maxOverlap can be set to a value greater than 1 to allow for multiple pixels to be placed at a particular position in a graphical visualization.

The value of overlapCount[p.x][p.y] for a particular position, represented by the combination of p.x and p.y (the x and y coordinates, respectively), is incremented by 1 (line 7 of the pseudocode above) each time a pixel is placed (painted) at the particular position represented by p.x and p.y (line 6 of the pseudocode above). The values of p.x and p.y are obtained at line 4 of the pseudocode, which obtains a position (p) of a pixel, where p contains the p.x and p.y values.

If no overlap of pixels is allowed, or if overlapCount[p.x][p.y] is not less than maxOverlap as determined at line 5 of the pseudocode, then a function RearrangeDataObject( ) is invoked at line 9 of the pseudocode above. The function RearrangeDataObject( ) is to position pixels sharing the same geometric coordinates (p.x and p.y) in a subregion, such as according to FIG. 4 discussed above. The pseudocode for the function RearrangeDataObject( ) is set forth below:

| | |
|---|---|
| 1 | rearrangeDataObject(o, p, overlapCount) |
| 2 | int squareSize := getLast UsedSquareSize(p); |
| 3 | Point[ ] squarePoints := calcSquarePoints(p, squareSize); |
| 4 | while new place not found do |
| 5 | if any squarePoints left |
| 6 | Point p := next squarePoint; |
| 7 | if (overlapCount[p.x][p.y]<maxOverlap) |
| 8 | o.setPaintPos(p); |
| 9 | overlapCount[p.x][p.y]++; |
| 10 | else |
| 11 | squareSize++; |
| 12 | squarePoints := calcSquarePoints(p, squareSize); |
| 13 | end while; |
| 14 | updateLastUsedSquareSize(p, squareSize); |

The RearrangeDataObject( ) function searches in a square (such as the subregion 402 of FIG. 4) around the original position (e.g. position corresponding to the pattern 404 in FIG. 4) for the next available position (e.g. one of the positions represented by legend 408 in FIG. 4). This determination is performed using the code at lines 2-5 of the RearrangeDataObject( ) pseudocode above. If an available position is found, then the pixel can be placed at the corresponding available position, as performed at lines 6-9 of the RearrangeDataObject( ) pseudocode above. If an available position is not found in the square, then the RearrangeDataObject( ) function increases the size of the square until an available position is found (lines 10-12 of the RearrangeDataObject( ) pseudocode above). The functions getLastUsedSquareSize and updateLastUsedSquareSize in the RearrangeDataObject( ) pseudocode above (lines 2 and 14) are used to retrieve and store, respectively, the last used size for a square at the specific position. The function calcSquarePoints (line 3 in the RearrangeDataObject( ) pseudocode above) determines all pixels that are on a square with the given size around the center position.

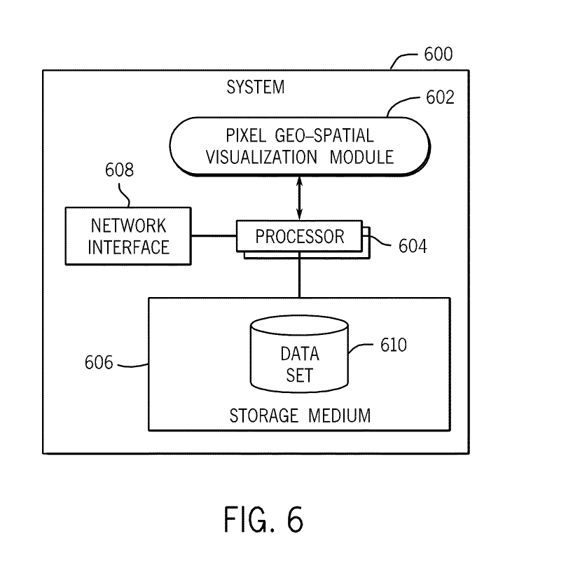

FIG. 6 is a block diagram of an example system 600 that has a pixel geo-spatial visualization module 602 according to some implementations. The pixel geo-spatial visualization module 602 can perform various tasks discussed above, including those depicted in connection with FIG. 3 and the tasks performed by the doPixelPlacement( ) and rearrangeDataObject( ) functions. The pixel geo-spatial visualization module 602 can be used to produce the graphical visualizations of FIG. 1 or 5, for example.

The pixel geo-spatial visualization module 602 can be implemented as machine-readable instructions executable on one or multiple processors 604. The processor(s) 604 can be connected to a storage medium (or storage media) 606 and to a network interface 608. A processor can include a microprocessor, a microcontroller, processor module or subsystem, programmable integrated circuit, programmable gate array, or another control or computing device. The storage medium 606 can store a data set 610 that has been received by the system 600, where the dataset 610 can include various data records that contain a sentiment attribute and attributes relating to geometric coordinates.

The storage medium 606 can be implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method executed by a computer, comprising:
receiving data records representing user feedback, wherein the data records are associated with geometric coordinates;
placing a plurality of pixels representing the corresponding data records in positions in a graphical visualization according to the geometric coordinates of the data records, wherein the positions correspond to geographic locations; and
placing a subset of the pixels sharing a particular set of geometric coordinates in a subregion of nearby positions in the graphical representation, wherein the pixels in the subset are placed in an order in the subregion according to values of an attribute of the data records corresponding to the pixels in the subset.

2. The method of claim 1, wherein the attribute is a sentiment attribute, the method further comprising assigning visual indicators to the plurality of pixels according to values of the sentiment attribute of corresponding data records.

3. The method of claim 2, wherein assigning the visual indicators comprises assigning different colors to the plurality of pixels according to the values of the sentiment attribute of corresponding data records.

4. The method of claim 3, wherein assigning the different colors comprises assigning a first color to pixels associated with sentiment attribute values expressing a negative user sentiment, and a second, different color to pixels associated with sentiment attribute values expressing a positive user sentiment.

5. The method of claim 1, wherein placing the subset of pixels in the subregion comprises placing the subset of pixels in a rectangular subregion.

6. The method of claim 1, further comprising arranging the plurality of pixels in the graphical visualization in the positions corresponding to the geographic locations in a geographic map.

7. The method of claim 1, further comprising:
receiving input corresponding to a user-activatable control element that specifies an amount of overlay of pixels sharing geometric coordinates,
wherein placing the plurality of pixels is according to the received input.

8. The method of claim 1, wherein the received input specifies no overlay of pixels sharing geometric coordinates is allowed.

9. The method of claim 1, wherein the received input specifies that a number of pixels sharing geometric coordinates that can be overlaid at a particular position in the graphical visualization.

10. An article comprising at least one machine-readable storage medium storing instructions that upon execution cause a system to:
receive data records representing user feedback, wherein the data records are associated with geometric coordinates;
generate a graphical visualization including pixels representing corresponding ones of the data records placed in positions according to geometric coordinates of the data records, wherein the positions correspond to geographic locations in a geographic map; and
place a subset of the pixels sharing a particular set of geometric coordinates in a subregion of nearby positions in the graphical visualization, wherein the pixels in the subset are placed in an order in the subregion according to values of a sentiment attribute of the data records corresponding to the pixels in the subset.

11. The article of claim 10, wherein the geometric coordinates comprise a latitude and a longitude.

12. The article of claim 10, wherein placing the subset of pixels comprises:
identifying available unoccupied positions in the subregion; and
placing pixels in the subset in the available unoccupied positions.

13. The article of claim 10, wherein placing the pixels in an order in the subregion according to values of the sentiment attribute comprises grouping pixels sharing a same sentiment attribute in the subregion.

14. The article of claim 13, wherein the instructions upon execution cause the system to assign colors to the pixels in the subregion according to the sentiment attribute values, wherein the grouping causes pixels sharing a same color to be grouped together in the subregion.

15. The article of claim 10, wherein the instructions upon execution cause the system to further:
display information of a particular pixel in response to user input moving a cursor over the particular pixel.

16. The article of claim 10, wherein the instructions upon execution cause the system to further:
place a second subset of the pixels sharing a second set of geometric coordinates in a second subregion of nearby positions in the graphical visualization, wherein the pixels in the second subset are placed in an order in the second subregion according to values of the sentiment attribute of the data records corresponding to the pixels in the second subset.

17. A system comprising:
at least one processor to:
receive data records representing user feedback, wherein the data records are associated with geometric coordinates;
place a plurality of pixels representing the corresponding data records in positions in a graphical visualization according to the geometric coordinates of the data records, wherein the positions correspond to geographic locations; and
place a subset of the pixels sharing a particular set of geometric coordinates in a subregion of nearby positions in the graphical representation, wherein the pixels in the subset are placed in an order in the subregion according to values of a sentiment attribute of the data records corresponding to the pixels in the subset.

18. The system of claim 17, further comprising assigning colors to the plurality of pixels according to values of the sentiment attribute of corresponding data records, wherein the subregion includes a group of pixels sharing a same color.

19. The system of claim 17, wherein the graphical visualization includes a user-activatable control element to specify an amount of overlay of pixels sharing geometric coordinates that is allowed, and wherein placing the plurality of pixels is according to the user-activatable control element.
